(19) United States
(12) Patent Application Publication
(10) Pub. No.: US 2004/0011032 A1
(43) Pub. Date: Jan. 22, 2004

(54) Hydrodynamic coupling, operating resources supply system for hydrodynamic coupling and starter unit with a hydrodynamic coupling

(76) Inventors: Heinz Holler, Crailsheim (DE); Reinhard Kernchen, Satteldorf (DE); Achim Menne, Crailsheim (DE); Werner Klement, Heidenheim (DE)

Correspondence Address: BAKER & DANIELS, 111 E. WAYNE STREET, SUITE 800, FORT WAYNE, IN, 46802

(21) Appl. No.: 10/363,115

(22) PCT Filed: Jul. 16, 2001
(86) PCT No.: PCT/EP01/08185

(30) Foreign Application Priority Data
Aug. 31, 2000 (DE) 10043146.1

(51) Int. Cl. F16D 33/02

(52) U.S. Cl. 60/347

(57) ABSTRACT

The invention relates to a hydrodynamic coupling (1), comprising two blade wheels—a pump wheel (2) and a turbine wheel (3)—which together form a toroidal working chamber (4); a pump wheel shell (6) which is rotationally fixed to the pump wheel (2) and which surrounds the turbine wheel (3) in an axial direction, hereby forming a first guiding channel or chamber (9) for the operating means; and a second guiding channel or chamber (12) for the operating means which opens out in the area of the inner diameter of the toroidal working chamber (6) or below the same. The first and second guiding channels or chambers (12) for the operating means may be used as a supply or discharge channel or chamber to or from the toroidal working chamber (4), respectively.

The invention relates to a hydrodynamic coupling, specifically with the characteristics of the general concept of claim 1; furthermore, an operating resources supply system for a hydrodynamic coupling and a starter unit with a hydrodynamic coupling.

Starter units for use in manual transmissions, automatic transmissions or machine gears are familiar in many types of executions. As a rule, these encompass a hydrodynamic design element in the form of a hydrodynamic revolution/torque converter or a hydrodynamic coupling. Please refer to the document DE 198 04 635 A1 for a feasible execution of a starter unit for use in gears with a hydrodynamic coupling. This document discloses an execution of a starter unit with a short axial design length, encompassing a pump wheel and a turbine wheel that together form a toroidal working chamber, whereby the pump wheel is arranged on the motor drive side, i.e. the turbine wheel is spatially arranged between the entry of the starter unit and the pump wheel. For this purpose, the pump wheel is connected in a rotationally fixed manner with the entry and with a rotationally fixed drive coupled with the entry via an element which simultaneously forms the pump wheel shell. There is a bridge coupling placed parallel to the hydrodynamic coupling. This enables power transfer from the entry of the starter unit to the exit through circumvention of the hydrodynamic design element. The bridge coupling is thereby arranged as a separate design element next to the unit out from the pump wheel and turbine wheel. Furthermore, the starter unit encompasses a device for attenuation of oscillations which is placed in a diameter area which is arranged above the extreme radial measurement of the toroidal working chamber of the hydrodynamic coupling and is a component of the bridge coupling and forms a coupling element. In other words, the device oscillation attenuation is essentially on the area of a plane or slightly set against the hydrodynamic coupling. This solution relatively short build but does not, however, fulfill the requirements of certain prescribed installation situations with respect to the required axial design length. Furthermore, this execution is characterized by a high number of design components and enormous assembly effort due to the high number of functional elements.

The invention is therefore intended for the task of further developing a starter unit of the type mentioned above, encompassing a hydrodynamic coupling, that may be reversed in parallel manner, as well as in its individual elements in such a way that the starter unit is characterized by a very small design space requirement in an axial direction and a small number of design components and the combination of functional elements. The assembly effort should thereby be kept at a minimum.

The solution described in the invention is characterized by the characteristics of claims 1, 4, and 11. Advantageous arrangements are described in the sub-claims.

A hydrodynamic coupling with two blade wheels—one pump wheel and one turbine wheel—that together form a toroidal working chamber, encompasses a pump wheel shell that is rotationally fixed and coupled to the pump wheel and surrounds the turbine wheel in an axial direction hereby forming a first guiding channel or chamber.

Furthermore, there is a second guiding channel or chamber, which joins in the area of the internal diameter of the toroidal work chamber and or below it. According to the invention, the first and second guiding channel or chamber may be used alternately as an inflow or outflow channel or chamber of the toroidal working chamber. Through this alternate change in the function of the individual guiding channel or chamber, the flow direction of the hydrodynamic coupling can easily be changed between centripetal and centrifugal.

The invention solution forms the basic design requirements for the construction of a hydrodynamic coupling used in the creation of a starter unit with a minimum axial design length for starter units that utilize a bridge coupling and pressure build-up for the bridge coupling via the operating resources movement of the hydrodynamic coupling.

To achieve inflow of the operating resources when there is centripetal flow, i.e. flow of the hydrodynamic coupling via the first guiding channel or chamber to the extreme radial area of the toroidal working chamber in the area of the separation plane between the pump and turbine wheel and from there into the working cycle that is forming in the toroidal working chamber, it is necessary to arrange the pump wheel and turbine wheel so as to form a gap between them in such a way the entry angle formed always causes an inflow into the meridian flow working cycle and does not cause an outflow effect. For that reason, the pump wheel and turbine wheel are executed using a skew notch.

The operating resource system arranged for the hydrodynamic coupling encompasses an operating resource supply source and a first connection for coupling with the first guiding channel or chamber as well as a second connection for coupling with the second guiding channel or chamber. According to the invention, a means for alternating change in the flow direction of the hydrodynamic coupling are planned through allocation of the inflow or outflow function to both operating resources supply channels or chambers. The concept of connection is not only understood as a design element but also as a functional element with respect to its function. This means the transfer between the operating resources supply channels or chambers of the hydrodynamic coupling and the connecting lines to the operating supply source. Individual elements of the operating resource supply system may or may not thereby also be a component of the hydrodynamic coupling. This especially applies to means for reversible change in the flow direction of the hydrodynamic coupling through allocation of the inflow or outflow function to both of the operating resources supply channels or chambers and/or parts of the connecting lines between the operating resources supply source and the guiding channels or chambers.

With the operating resources supply system of a hydrodynamic coupling formed in the invention, the flow direction of a hydrodynamic coupling can be changed easily without design modifications. The basic construction of a hydrodynamic coupling is maintained according to claim 1.

With regard to the formation of the operating resources supply system, there are several possibilities. The concrete execution takes place according to the requirements for how the system is being used and is left to the judgment of the responsible technician.

In a particularly simple formation, the means encompass a valve apparatus with at least two switch settings. The first switch setting is characterized by the coupling between the inflow and the first guiding channel or chamber and the outflow and the second guiding channel or chamber and the second switch setting by the coupling between the inflow and the second guiding channel or chamber and the outflow and the first guiding channel or chamber. Both guiding channels or chambers are preferably coupled via an open cycle with one another.

The execution of the hydrodynamic coupling deals with a flow coupling, i.e. a design element that allows only one revolution conversion upon power transfer between one drive and another drive, i.e. opposite a converter free from a torque conversion and thereby is compulsorily coupled to the number of revolutions. These can be regulated or unregulated. Regulated hydrodynamic couplings are couplings in which the filling degree during operation can change randomly between full and empty, whereby the power increase and thereby the transfer capability of the coupling can be set and makes step-free revolution regulation of the drive machine and/or drive side possible independent of load. The hydrodynamic coupling can thereby be formed as a coupling with a toroidal working chamber that is formed from a primary blade wheel functioning as a pump wheel and a secondary blade wheel functioning as a turbine wheel or as a so-called double coupling, i.e. with two toroidal working chambers formed from a primary blade wheel and a secondary blade wheel. The ability to regulate exists primarily via the change of the mass flow, i.e. the influence of the degree of filling in the working chamber and the cycle of operating resources in the working

cycle. The control and/or regulation of the filling degree of the hydrodynamic coupling then occurs preferably via pressure control. The change in the absolute pressure in the toroidal working chamber is then coupled with the change in filling degree. Therefore, conditions of partial filling can be set by changing absolute pressure. This ability to make settings makes it possible, with respect to various criteria, for example, energy consumption and harmful emissions, to control optimized operation points in the operation area of the drive machine.

According to one further advantageous development, it is possible to couple the individual guiding channels or chambers with one another via an open cycle and provide each, or at least one, guiding channel or chamber with a controllable valve apparatus, whereby the flow direction and the transferable performance in the hydrodynamic coupling can be determined by setting the pressure values that need to be set in the guiding channels or chambers.

The starter unit created by the hydrodynamic coupling described in the invention with the characteristics of claim 1 encompasses an entry that may be coupled with a drive and an exit that may be coupled with an drive. The hydrodynamic coupling is arranged between the entry and the exit. A pump wheel shell is arranged for the pump wheel, which is connected to the pump wheel in a rotationally fixed manner and surrounds the turbine wheel in an axial direction by creating the first guiding channel or chamber. The pump wheel shell may be designed as one part with the pump wheel, preferably, however, multiple part executions will be used, whereby the rotationally fixed connection occurs via a corresponding connecting element or other coupling possibilities. Furthermore, the

hydrodynamic coupling encompasses a second guiding channel or chamber which leads into the area of the internal diameter of the toroidal working chamber or below it. According to the invention, the first and second guiding channel or chamber may be used alternatively as an inflow or outflow channel or chamber to the toroidal working chamber. The flow direction of the hydrodynamic coupling may be changed easily between centripetal and centrifugal through the alternate change in the function of the individual guiding channels and chambers. The starter unit also encompasses a coupling that can be switched, in particular, a bridge coupling, which may be switched parallel to the hydrodynamic coupling. This means, as a rule, in particular for use in automated gears, the power transfer occurs during a majority of the operation of the starter unit via only one of the two elements—a hydrodynamic coupling or bridge coupling. In the first case, the power transfer occurs via a hydrodynamic power branch when utilizing the advantages of the hydrodynamic power transfer, whereas in the second case, the power transfer occurs essentially mechanically via mechanical through-coupling. There is, however, the possibility that both elements at least have joint operating in the transfer area, i.e. upon switching between hydrodynamic and mechanical performance branches. This joint operation is, however, of limited duration and should not exceed specific, pre-defined times. The bridge coupling is executed as a mechanical coupling, preferably in disk form.

The bridge coupling encompasses at least a first coupling element in the form of a first a thrust plate and a second coupling element in the shape of a second thrust plate that

may be brought into a working connection with each other at least indirectly, i.e. either directly or indirectly into contact with one another via further transfer means. This process will include integration of components of the bridge coupling in the hydrodynamic design element. This will be realized by connecting a coupling element, as a rule a first thrust plate rotationally fixed with the entry, in particular the primary wheel shell, while the second thrust plate is connected in a rotationally fixed manner with the exit, preferably the turbine wheel. The thrust plates are equipped with means to generate contact pressure and thereby generates at least one indirect striking connection between the first thrust plate and the second thrust plate.

The invention solution makes it possible to form a starter unit with very small design space needs in an axial direction through integration of the individual elements of the starter unit in the form of the hydrodynamic coupling, because the existing design elements have already been entrusted simultaneously with the takeover of the function of the other elements.

The means for generating contact pressure encompasses at least one piston element that can be struck with pressure. This element can be equipped separately on the thrust plates. In a particularly compact and therefore advantageous formation, however, the turbine wheel is used as a piston element. The pressure chamber for striking the piston element is formed from the part of the toroidal working chamber enclosed by the turbine wheel. With respect to the design execution for takeover of an element function and, furthermore, of an element of the means for generating contact pressure, there are essentially the following possibilities:

1. rotationally fixed coupling of the turbine wheel with the exit of the starter unit;

however, with the ability to move the turbine wheel along the axel;

2. rotationally fixed connection of the turbine wheel with the exit of the starter unit and elastic execution of the coupling between turbine wheel and exit in an axial direction.

In the first case, the striking connection between the first thrust plate and the second, rotationally fixed thrust plate connected with the turbine wheel is achieved via movement of the turbine wheel, whereas in the second case only one reversible formation of the connection between the turbine wheel and the exit of the starter unit makes pressing possible. Both solutions are suitable for executions for a small axial distance in the uncoupled condition between the first and second thrust plates, whereas the first named solution is also conceivable for larger distances. The axial moveability of the turbine wheel occurs in a range of 0.1 to 2 mm.

In order to realize almost automatic bridging and, moreover, a safe operating manner upon power transfer via the hydrodynamic coupling, a counteracting force is required for axial moveability of the turbine wheel, which fixes the turbine wheel in its position opposite the pump blade wheel. This counteracting force is generated in the invention by a operating resource that is added to the working chamber, which is conducted along the periphery of the turbine wheel between the individual thrust plates of the bridge coupling in the areas of the separation plane between the pump wheel and the turbine wheel in the area of the external diameter of the toroidal working chamber and from there brought into the pump wheel and flows centripetal through the hydrodynamic coupling. Normally, both

thrust plates of the switchable coupling lie close to one another. The remaining gap in the 10^{th} mm range serves as a throttle site for the flowing operating resources. A pressure difference between the piston surfaces is set by this throttle site, resulting in the required contact pressure for opening and closing the bridge. In the simplest case of execution with a rotationally fixed connection and axial moveability, this can be realized through the bias of the turbine wheel, for example, by means of at least one spring mechanism. As an analogy, this is also possible for the elastic connection of the turbine wheel to the exit occurring in an axial direction. Upon switching from hydrodynamic operation to mechanical drive, the direction of the operating resources supply is changed, i.e. the flow occurs centrifugal but no longer around the periphery of the turbine wheel. The counteracting force between the thrust plates brought about by the centripetal flow of the operating resources supply affecting the turbine wheel dissipates. The operating resources will now be added to the toroidal working chamber in the area of the internal periphery and the contact pressure generated by the operating resources on the turbine wheel causes a movement in the direction away from the pump wheel, whereby the thrust plate connected in a rotationally fixed manner to the turbine wheel is brought into an effective connection in a striking position with the thrust plate coupled with the pump wheel shell.

With respect to the connection of the first and second thrust plates to the turbine wheel and the pump wheel shell, there are a number of possibilities. The spatial arrangement occurs in an axial direction viewed next to the toroidal working chamber and behind it. The arrangement in radial direction is characterized by internal and external measurements, which preferably will be in the area between the external and internal diameter of the toroidal working chamber.

Preferably, the striking surfaces, which are formed by the thrust plates, are aligned parallel to the separation plane between the pump wheel and the turbine wheel so that the required contact pressure is kept to a minimum; technical completion tolerances may be balanced out without difficulty.

Preferably, the rotationally fixed coupling with the turbine wheel occurs directly on the backside of the part of the turbine wheel that forms the torus. The rotationally fixed connection of the individual thrust plates with the turbine wheel and the pump wheel shell can also be realized in various ways. The following are conceivable:

a) the one-part execution of thrust plate and turbine wheel and/or thrust plate and pump wheel shell;

b) formation of the individual thrust plates as separate design elements and rotationally fixed coupling via corresponding connection elements with the pump wheel and/or the turbine wheel.

In both cases, the striking surfaces can be formed directly from the thrust plate, i.e. in the first case from the external side of the turbine wheel and an interior surface of the pump wheel shell and in the second case from the separate design elements comprise a striking layer added to the exterior periphery of the turbine wheel or the individual thrust plates.

Under another especially advantageous version of the invention, the starter unit encompasses a device for attenuating oscillations, in particular a torsion oscillation attenuator. This is added to

the hydrodynamic design element in the form of the hydrodynamic coupling and to the bridge coupling, preferably in a sequence. This is achieved by arranging the attenuator for oscillations between the turbine wheel and the exit. This means that the turbine wheel is coupled to the entry of the device of attenuating oscillations or via striking connection upon bridging of the hydrodynamic performance bridge the entry of the device for attenuating oscillations is connected in a rotationally fixed manner with the pump wheel via the pump wheel shell. The arrangement of the device for attenuating oscillations occurs spatially in an axial direction viewed essentially in the area or in a level with the hydrodynamic design element. The device for attenuating oscillations within the diameter describing the portion of the hydrodynamic coupling forming the interior periphery of the toroidal work chamber is arranged in a radial direction. With this execution, the design space available in a radial direction will also be used optimally next to an especially short axial construction length. With reference to the execution of the device for attenuating oscillations, there are no restrictions, i.e. any type of oscillation attenuator is conceivable. Devices for attenuating oscillations that are based only on striking attenuators or hydraulic attenuators, for example, are sufficient for use. The execution as a hydraulic attenuator encompasses means for the spring and/or attenuator coupling between the primary portion and the secondary portion next to a primary portion and a secondary portion which may be coupled with one another in a rotationally fixed manner for purposes of torque transfer and may be rotated in the periphery direction against each other at a specific angle. The means for the attenuator coupling encompass chambers that may be filled with hydraulic fluid in which oscillations are transferred. The device for attenuating oscillations must be arranged only on the exit area on the turbine wheel, for which the device for attenuating oscillations in radial and axial direction is built very small and, as a rule, does not cause any enlargement of start unit measurements given for the hydrodynamic design element.

Other arrangements of the device for attenuating oscillations are also conceivable, for example, in only one power branch to the switchable coupling in front of or in a sequence behind this coupling or to a hydrodynamic coupling.

With respect to the spatial arrangement of the pump wheel and turbine wheel connected to the entry and exit of the starter unit, there are essentially the two following possibilities:

1) Arrangement of the pump wheel in an axial direction between the entry of the starter unit and the turbine wheel of the hydrodynamic coupling;

2) Arrangement of the turbine wheel of the hydrodynamic coupling in an axial direction between the entry of the starter unit and the pump wheel.

Preferably the latter possibility will be used because, in this case, the collision possibilities of the individual elements can be optimally controlled despite a small design space.

The invention solution is suited for use in gears, in particular for automated gears, and also in gears with step-free gear parts (CVT), for example, in the form of toroidal gears or pulling gears. The starter unit can thereby be treated

a separate pre-installed design element. The connection with the gears occurs through integration in the gear housing or switching behind each other with gear steps, whereby in both cases the coupling can be realized by extending into a shaft that can be coupled with power gear steps or a step-free gear part.

Under another version of the invention, the starter unit described in the invention is suited both for use in driving belts in stationary systems and in vehicles.

The invention solution is illustrated in the following with figures. The following are presented individually:

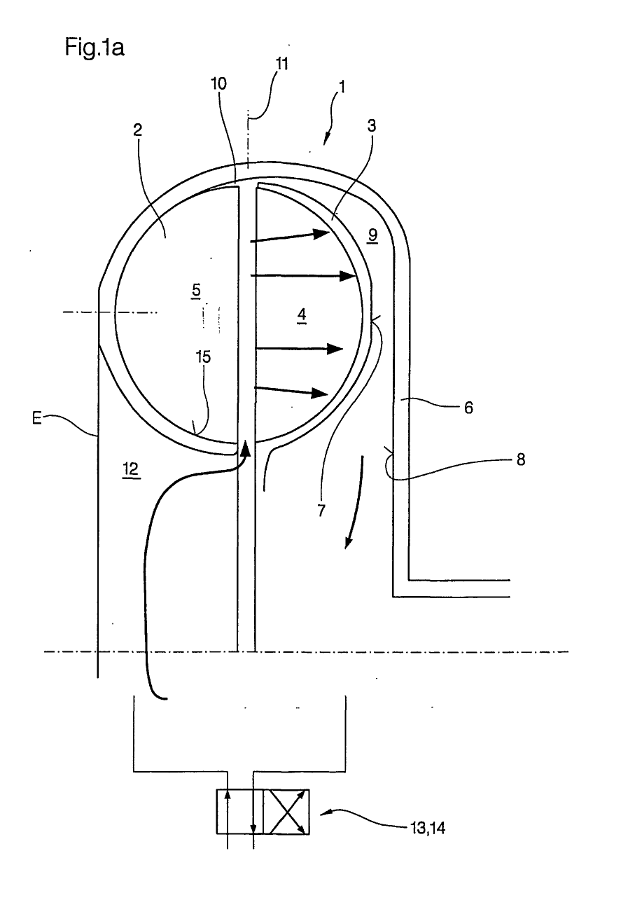

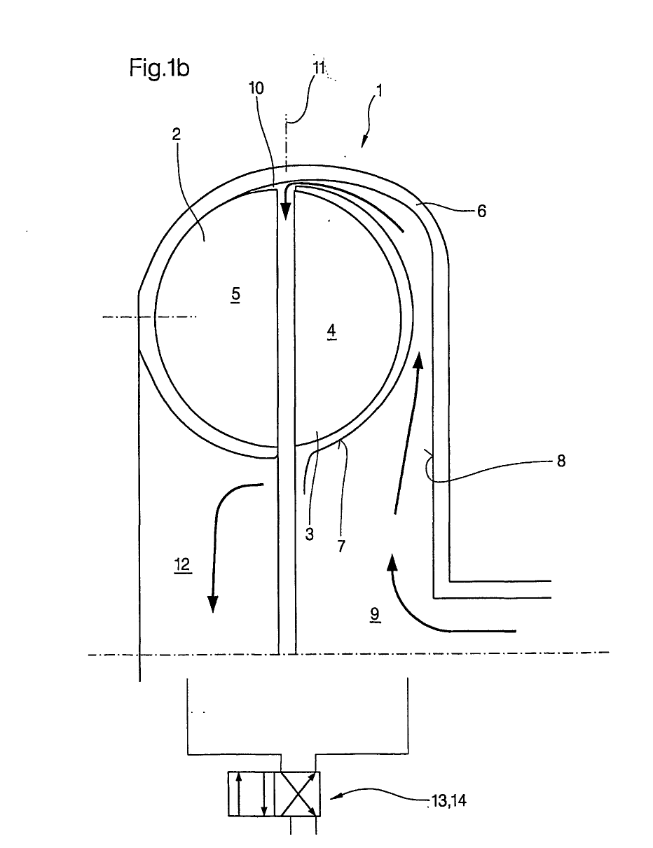

FIGS. 1a and 1b illustrate the basic principle of the alternating change in flow direction of a hydrodynamic coupling contained in the invention;

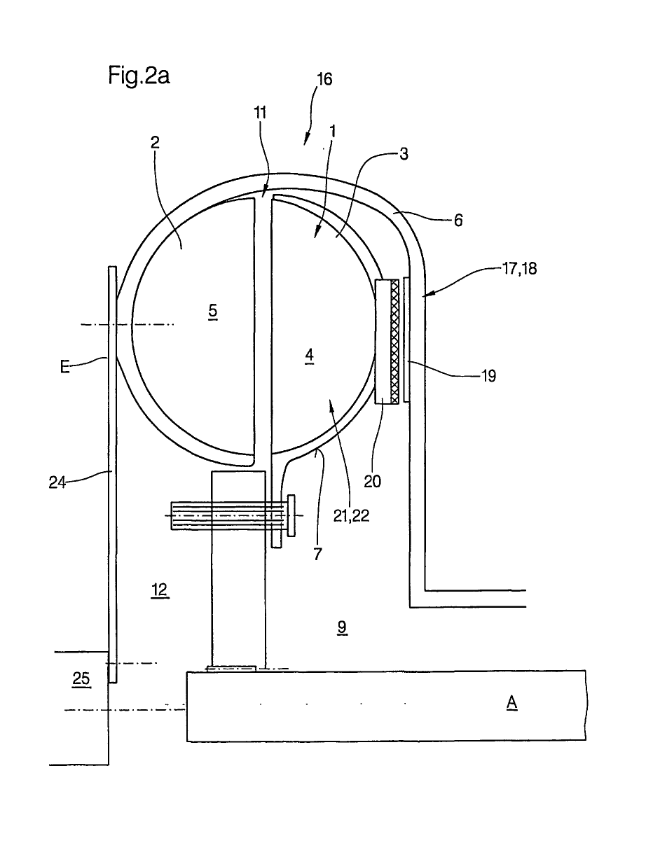

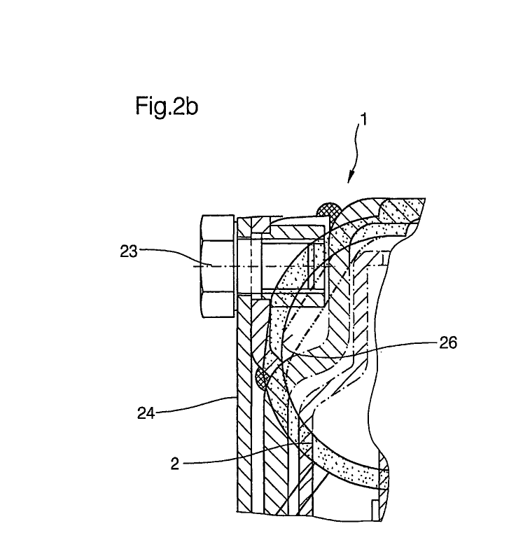

FIG. 2a illustrates an advantageous formation of a starter unit described in the invention;

FIG. 2b illustrates a detail described in FIG. 2a;

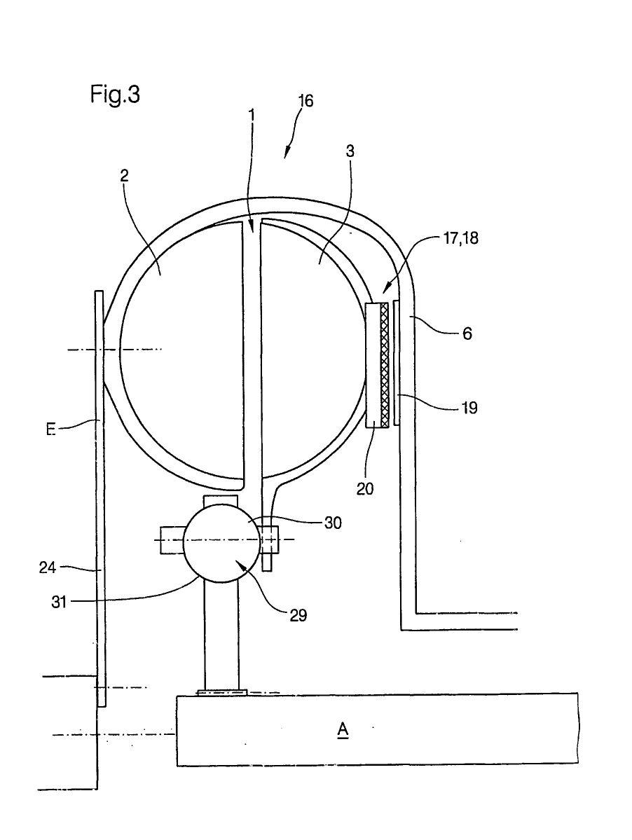

FIG. 3 illustrates an advantageous formation of what is described in FIG. 2a;

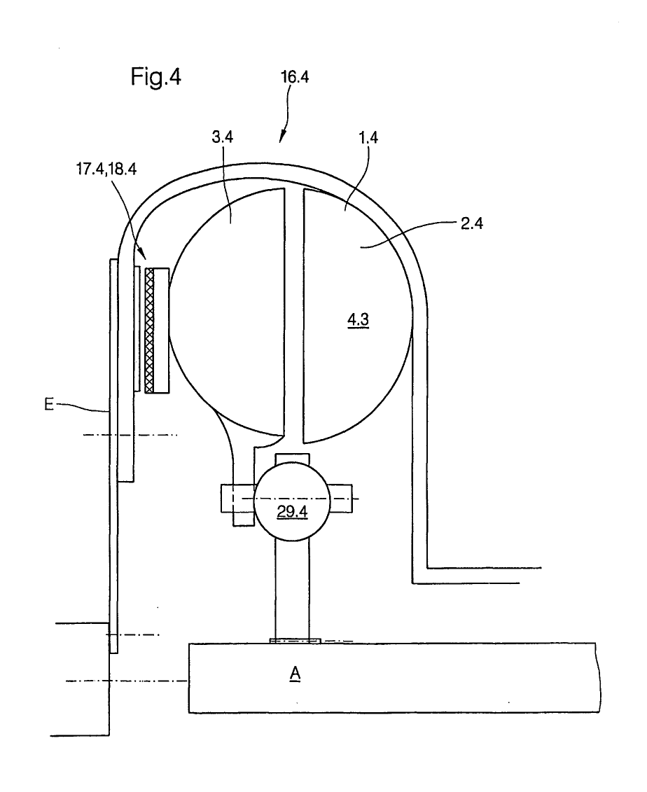

FIG. 4 illustrates an advantageous execution of a starter unit opposite the executions described in FIG. 2 and FIG. 3 with reversed blade wheels;

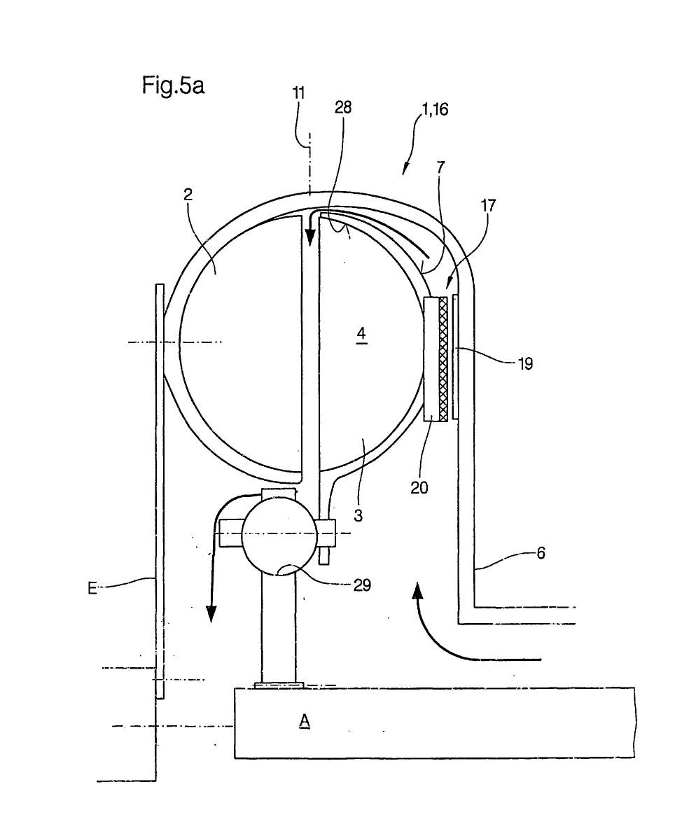

FIGS. 5a and 5b illustrate both of the flow conditions for an execution described in FIG. 2a;

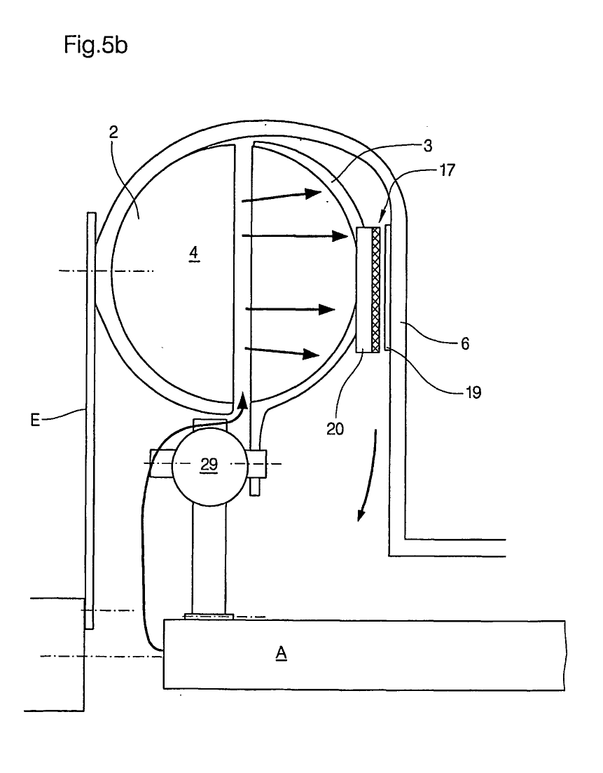

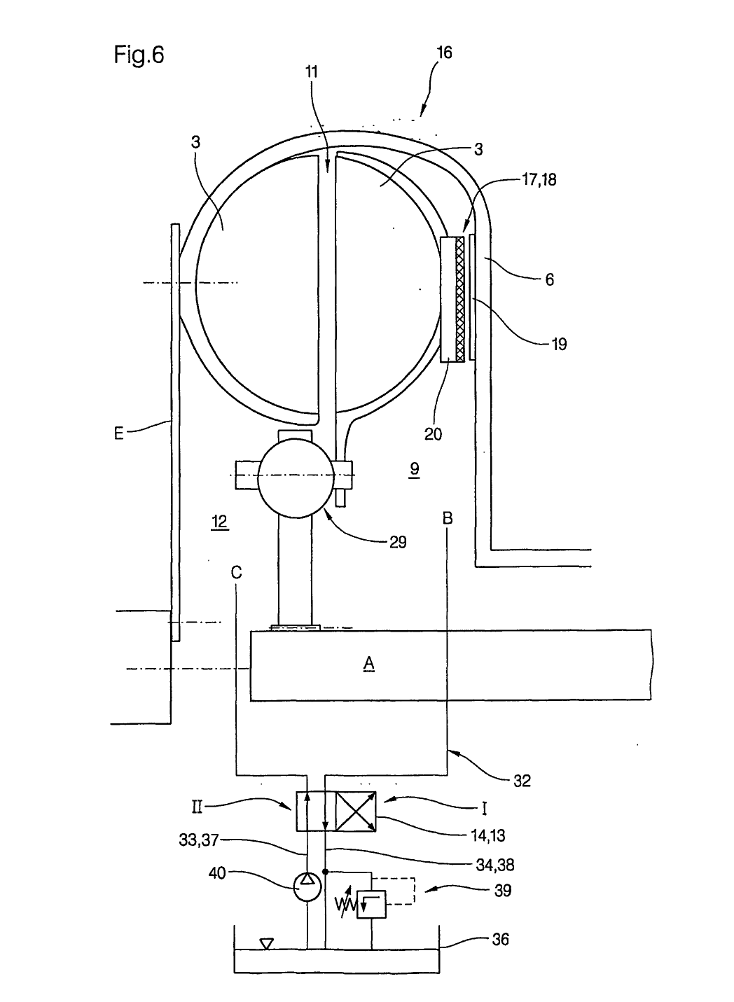

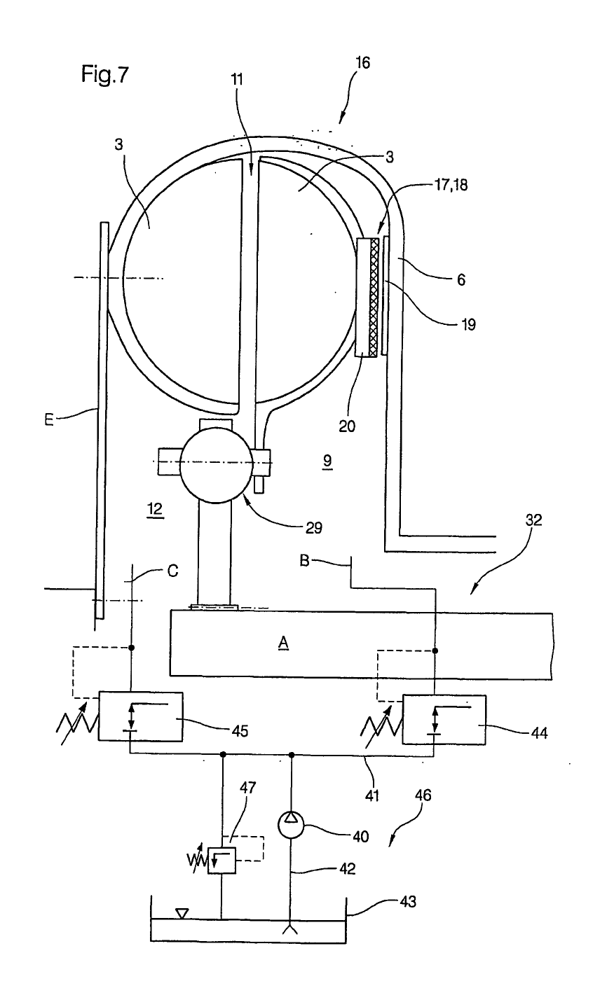

FIGS. 6 and 7 presents in a greatly simplified illustrated display of possibilities for realization of pressure control.

FIGS. 1a and 1b illustrate, in a simplified illustrated display, the basic principle of function changes by changing the flow of a hydrodynamic coupling 1. This encompasses a primary wheel described, as a rule, as a pump wheel 2 and a turbine wheel 3 described as a secondary wheel. Together both wheels form a toroidal working chamber 4, in which a closed work cycle 5 is formed by circulation of the operating resource during operation of the hydrodynamic coupling. The primary wheel 2 is coupled in a rotationally fixed manner with a pump wheel shell 6, which surrounds the turbine wheel 3 in an axial direction. The pump wheel shell 6 surrounds the turbine wheel 3 in such a way that at least one guiding channel or chamber 9 is formed to move the operating resources between the external periphery 7 of the turbine wheel and the interior contour 8 of the pump wheel shell. Individually, this will enable the inflow of operating resources between the turbine wheel 3 and the pump wheel shell 6 in the area of the extreme radial measurement 10 of the hydrodynamic coupling 1, especially the primary wheel 2 and the turbine wheel 3 in the area of a separation plane 11 between the pump wheel 2 and the turbine wheel 3 from above in the direction of the work cycle 5 being set in the toroidal working chamber 4 and achieving a centripetal flow. Furthermore, at least one guiding channel or chamber 12 is added to the hydrodynamic coupling, which enables movement of the operating resources to the toroidal working chamber 5 in a centrifugal direction. For the guiding channel or chamber 12, this may be a

line or special channel formed and incorporated in the connection design. The term ‘channel’ is to be viewed with respect to the function and can also include internal spaces or combined channel and chamber sections. The guiding channel or chamber 9 in particular is a circular operating resources space. Furthermore, each of the guiding channels is formed in such a way that they can also serve to draw away, in addition to adding, operating resources to the toroidal working chamber 4, i.e. is thereby a connection with at least one entry and or exit from the toroidal working chamber 4. It is therefore insignificant in which areas the operating resources exit from the toroidal working chamber 4. According to the invention, both guiding channels or chambers 9 and 12 may be used alternatively to draw in or expel operating resources so that the flow direction also changes. To do so, there will be means for alternate change in the flow direction 13 of the hydrodynamic coupling 1. These means can also be characterized as flow direction change means. In the simplest case, these means encompass a valve apparatus which reverses the function of the described operating resources channel or operating resources movement chamber with respect to the function of drawing in or expelling operating resources. The valve apparatus is thereby, in the simplest case, executed as a 4/2 direction valve apparatus 14. The second valve placement of the valve apparatus presented in FIG. 1 a is characterized by the fact that there is centrifugal flow through the hydrodynamic coupling 1. In this case, operating resources are moved in the area of the interior periphery 15 of the toroidal working chamber 4 via the guiding channel or chamber 12. In the first switch setting of the 4/2 direction valve displayed in FIG. 1b, the movement of the operating resources occurs via the guiding channel or chamber 9 at the exterior periphery 7 of the turbine wheel 3 and from there into the area of the separation plane 11 in the area of the extreme redial distance 10 of the

hydro dynamic coupling 1, into the toroidal working chamber 4. There will be centripetal flow through the hydrodynamic coupling upon cycle build-up. To achieve a safer manner of functioning and to be able to employ possibilities of pressure control, both guiding channels or chambers are insulated from each other, i.e. pressure insulated and impermeable.

The invention formation of a hydrodynamic coupling displayed in FIGS. 1a and 1b shows a necessary requirement to realize a special space-saving spatial arrangement of a starter unit 16 element as shown in FIG. 2a. FIG. 2a thereby illustrates in a greatly simplified manner the basic design of a starter unit 16, created as described in the invention, with a hydrodynamic coupling 1, created as described in the invention. The starter unit encompasses an entry E that may be coupled with a drive and an exit A that may be coupled with open gear transfer steps or a drive. The starter unit 16 encompasses a starter element in the form of the hydrodynamic coupling 1. The starter unit 16 also encompasses a coupling 17 that may be switched parallel to the starter element. This functions upon use in automatic transmission and in use of automated gears always or mainly as a bridge coupling 18. Bridge coupling refers to a switchable coupling setup, which enables power transfer in a drive system by circumventing a power branch. The switchable coupling 17 encompasses at least two coupling elements that may be brought into an effective striking connection, preferably in the form of thrust plates—in a power flow direction viewed between the entry E and the exit A of the starter unit—a first thrust plate 19, which can also be characterized as a coupling entry disc and a second thrust plate 20 that is also characterized as a coupling exit disc. An effective connection through contact striking between the first thrust plate 19 and the second thrust plate 20 can thereby be realized directly or indirectly. In the first case, the strike pairing of the first thrust plate 19 and the second thrust plate 20 is thereby formed directly, whereas in the second case there is a switch between the elements that bear striking surfaces. The pump wheel 2 of the hydrodynamic coupling 1 encompasses a pump wheel shell 6. This is formed either from a separate design element that is coupled in a rotationally fixed manner with the pump wheel 2 or is executed as an integral design element with the pump wheel 2. The pump wheel shell extends in a axial direction in the installation position, essential along the axial stretch of the turbine wheel 3 and surrounds this wheel also at least partially in the radial direction. Preferably the surrounding of the turbine wheel 3 by the pump wheel shell 6 and, in multiple part executionsm by their individual parts, occurs in such a way that these parts extend in a radial direction to the area of the exit A. The turbine wheel is thereby connected directly or indirectly with the exit A of the starter unit 16, i.e. via other transfer elements. The first thrust plate 19 is thereby connected in a rotationally fixed manner with the entry E and the second thrust plate 20 is connected in a rotationally fixed manner with the exit A of the starter unit 16. In the illustrated case, the first thrust plate 19 is coupled in a rotationally fixed manner with the pump wheel 3, in particular the pump wheel shell 6, whereas the second thrust plate 20 is connected in a rotationally fixed manner with the turbine wheel 3. Preferably the arrangement of the switchable coupling 17 occurs extending in a radial direction of the area of the toroidal working chamber 4. Furthermore, means 21 for generating contact pressure to realize a striking connection between the individual coupling elements, in particular the first thrust plate 19 and the second thrust plate 20, are planned.

The means 21 preferably encompass a piston element 22 that may be struck by means of pressure, whereby the function of the piston element 22 is taken over by the turbine wheel 3 in the presented case. The turbine wheel 3 is connected for this purpose either in a rotationally fixed manner, as indicated in the figure, but executed so that it may be moved in an axial direction or the connection to the exit A occurs in a direct rotationally fixed manner in the periphery direction where it can rotate stiffly and elastically in an axial direction. The guiding channels or chambers 12 and 9 are also recognizable, at least as indicated in a simplified illustration. The means 13 for alternative change in flow direction are equipped directly on the hydrodynamic coupling 1, in the hydrodynamic coupling 1 or attached to it. In the presented case, a 4/2 direction valve apparatus 14 is used for that purpose, as already described in FIG. 1. The 4/2 direction valve apparatus is thereby connected with the guiding channels or chambers 9 and 12 and accordingly controls the operating resources flow direction through the hydrodynamic coupling 1 according to its setting. To achieve the function of the hydrodynamic coupling 1 and thereby the power transfer via the work cycle to be set in the toroidal working chamber 4during operation, the movement of the operating resources to the working chamber 4 occurs in a centripetal manner, i.e. around the external periphery 7 of the turbine wheel 3 and thereby between the individual elements of the switchable coupling 17, in particular through the first thrust plate 19 and the second thrust plate 20. The counterforce conditioned by the movement of the operating resources flow enables an axial fixation of the turbine wheel 3 during power transfer in the hydrodynamic coupling 1. If the counterforce dissipates through diversion or change in the movement of the operating resources flow to the working chamber 4, the operating means in the toroidal working chamber 4 causes an axial force due to the building pressure in the working chamber 4, which is no longer supported by the turbine wheel 3, but leads to a movement of the turbine wheel 3 in an axial direction. This movement brings about an effective striking connection of both thrust plates of the switchable coupling device 17 so that the turbine wheel 3 is coupled mechanically to the pump wheel 2 whereby the piston element 22 struck with contact pressure is integrated in the hydrodynamic coupling 1 and is formed from the turbine wheel 3. The part of the turbine wheel 3 carrying the second thrust plate 20 takes over the function of the piston element 22 and the operating resources in the toroidal working chamber take over the function of pressure striking, with a piston element 22 functioning as a pressure hammer. In this operating condition, there is centrifugal flow through the hydrodynamic coupling.

The execution of the starter unit 16 displayed in FIG. 2a shows an especially advantageous arrangement of the individual elements—the pump wheel 2 and the turbine wheel 3—of the hydrodynamic coupling 1. In this execution, the turbine wheel 3 is arranged spatially in an axial direction behind the pump wheel or beside it in a power transfer direction between the entry E and the exit A of the starter unit 1, whereas the pump wheel 2 is arranged spatially between the entry E and the turbine wheel 3. Due to the integration of the means 21 for generating contact pressure to realize a striking connection of the individual elements of the switchable coupling 17, which functions in the presented case as a bridge coupling, into the hydrodynamic coupling 1, the number of required design elements can be reduced to a minimum because no additional separate setups for generation or preparation of contact pressure for the individual elements, in particular the first thrust plate 19 and the second thrust plate 20 of the switchable coupling 17, are required. Another significant advantage exists due to the integrated execution in the extremely short axial design length. The can be shortened further when using optimized blade wheel with the invention solution opposite the executions in the current state of technology.

In another version of the axial design space required for curtailing, the connection of the pump wheel 2 to the drive E occurs, according to an advantageous further development of a solution illustrated in FIG. 2a, by means of attachment elements 23, whereby the drive here occurs via the coupling of a so-called flex plate 24 with a crankshaft 25 of an drive machine not presented in detail, i.e. in an axial direction with membranes that are pliable and executed in a peripheral direction in a rotationally stiff manner. To reduce axial design length, it is also planned that the attachment elements 23 extend partially into the blade base 26 of the pump wheel 2. This is illustrated in FIG. 2b using details from a design execution of a starter unit 16 as shown in FIG. 2a. Due to the rotationally fixed connection between the drive and entry E and pump wheel 2, there is no relative movement between the attachment elements 23 and the pump wheel 2, in particular the blade base 26 of the pump wheel 2. A disruption of the meridian flow in the toroidal working chamber 4 or an inflow occurring during operation does not occur. This type of extending of the attachment elements 23 into the blade base 26 is displayed in FIG. 2b using a cross-section of the starter unit 16 created in the invention shown in 2a.

Preferably, the second thrust plate 20 is arranged on the backside, i.e. to the exterior periphery 7 of the turbine wheel 3, as shown in FIG. 2a. The arrangement occurs preferably parallel to the separation plane 11 between the pump wheel 2 and the turbine wheel 3, preferably in the area between the measurements of the internal diameter 27 and of the external diameter 28 of the toroidal working chamber 4. Then the second thrust plate 20 is formed preferably directly from the turbine wheel, whereby the striking surfaces can be generated from one layer brought up to the external surface of the secondary wheel 3.

In another aspect of the invention, the starter unit 16 shown in FIG. 3 encompasses a device for attenuating oscillations 29, in particular a torsion oscillation attenuator. This can be executed in many forms. In the simplest case, this is executed as a simple strike attenuator setup. Executions with hydraulic attenuation are, however, conceivable. With respect to the concrete formation of that type of device for attenuating oscillations 29, reference can be made to executions known from the current state of technology. Concrete selection is left to the judgment of the responsible technician. In a particularly advantageous way, the hydrodynamic coupling 1, the switchable coupling 17 and the device 29 for attenuating oscillations are switched in sequence. The device for attenuating oscillations 29 encompasses a primary part 30, which is connected in a rotationally fixed manner to the turbine wheel 3 and thereby the second thrust plate 20 and a secondary part 31, which is coupled with the exit A in a rotationally fixed manner. Means for attenuating and/or spring coupling are planned between the primary part 30 and the secondary part 31. The device for attenuating oscillations 29 is arranged according to the power transfer branch upon power transfer via the hydrodynamic coupling 1 between the hydrodynamic coupling 1, in particular the turbine wheel 3 and the exit A, as well as upon power transfer via the switchable coupling 17 between the switchable coupling 17, in particular to the exit formed by the second thrust plate 20 and the exit A of the

starter unit. In both cases the device 29 for attenuating oscillations is switched in sequence to the respective power transferring element—the hydrodynamic coupling 1 or switchable coupling 17. Also, when the hydrodynamic coupling 1 and swithable coupling 17 are operated simultaneously, i.e. power transfer via two power branches—transfer of a first power portion of the total power via the hydrodynamic coupling and transfer of the second power portion via the switchable coupling 17—the torsion oscillation attenuator is switched to both of the power branches in a sequence. The remaining basic construction of the starter unit corresponds to that described in FIG. 2a. The same reference signs are used for the same elements.

FIG. 4 illustrates in a simplified illustration another formation of a starter unit 16.4 formed according to the invention with a starter element 17.4 in the form of a hydrodynamic coupling 1.4. This hydrodynamic coupling 1.4 also encompasses a primary wheel 2.4 and a secondary wheel 3.4, which together form a toroidal working chamber. Furthermore, a switchable coupling 17.4 is also present that is switchable parallel to the hydrodynamic coupling. The basic function corresponds to that described in FIGS. 2 and 3. The same reference numbers are also used for the same elements. In contract to the execution in FIGS. 2 and 3, however, the turbine wheel 3.4 is spatially arranged in an axial direction viewed between the entry E and the pump wheel 2.4, i.e. the pump wheel 2.4 is arranged, opposite the executions of the preceding figures, not on the motor side but on the motor drive side. The coupling between a drive, in particular the entry E and the starter unit 16.4 and the pump wheel 2.4 occurs by surrounding of the secondary wheel 3.4 in an axial direction, whereby the connection of the turbine wheel to the drive occurs via

the exit A in a radial direction within the coupling gap between the entry E and the pump wheel 2.4 and spatially viewed between the entry E and the exit A of the starter unit in front of the coupling between the entry E and pump wheel 2.4.

FIGS. 5a and 5b illustrate the function of the starter unit 16 created in the invention using an execution as described in FIG. 3. The same reference numbers are used for the same elements. FIG. 5a illustrates the movement of operating resources to the working chamber 4 during hydrodynamic operation, i.e. power transfer via the hydrodynamic coupling 1 around the external periphery 7 of the turbine wheel 3 to the separation plane 11 between the pump and turbine wheel in the area of the exterior diameter 28 of the toroidal working chamber 4 and from there into the working chamber 4. There is centripetal flow through the hydrodynamic coupling 1 in this condition.

In contrast, FIG. 5b illustrates the changed movement of operating resources upon switching the switchable coupling 17 to the turbine wheel 3 in the area of the interior periphery of the working chamber 4 for purposes of building pressure on the blade base of the turbine wheel 3 to the interior diameter of the toroidal working chamber 4. In this operating condition, there is centrifugal flow through the hydrodynamic coupling.

Using a further advantageous development, FIG. 6 illustrates the ability to control the power start of the hydrodynamic coupling 1 by means of both indirect and direct pressure control. For this purpose, one of the executions of the starter unit 1 as described in FIGS. 2 and 3 is equipped to the guiding channels or chambers 9 and 12, which are insulated against each other by means of a gasket that is not displayed in detail. The

movement of the operating resources occurs outside of the toroidal working chamber 4 for purposes of cooling via an open cycle 32.

The change of flow through the hydrodynamic coupling 1, as shown in FIGS. 1 and 5, also occurs via a valve apparatus 14, for example, that determines the arrangement of individual guiding channels or leads to inflow or outflow corresponding to how the switch is set. In the presented case, the inflow and outflow are designated with 33 and 34, whereby there coupling to the guiding channels or chambers can occur freely. In a first function setting of the valve apparatus 14 not presented here, the connection presented as an inflow with 34 and the connection presented with 33 functions as a back flow. The connection displayed with 24 is coupled with channels for movement of the operating resources around the exterior periphery 7 of the turbine wheel 3, which are not displayed in detail. In this condition, the coupled operating resources stream, upon movement between the thrust plates 19 and 20 that are to be brought together into a striking connection, serves to deactivate the switchable coupling 17 executed as a bridge coupling. There is centripetal flow through the hydrodynamic coupling 1 in this condition. This means a flow direction to the center, into the center of the work cycle 35 taking place in the toroidal working chamber 4. In the second function setting II of the 4/2 direction valve apparatus 14 displayed in FIG. 6, the connection designated B functions as an outflow and the connection designated C functions as an inflow. In this case the operating resources are introduced centrifugally from the direction of the rotation axel into the toroidal working chamber 4 and brings about the function displayed in FIG. 5b. The turbine wheel 3 of the hydrodynamic coupling 1 functions as a piston element for the thrust plates 19

and 20 of the switchable coupling 17 that are brought into a striking connection with one another. The open cycle contains a container 36. A feeder line 37 and a return line 38 are coupled with the container, which may be coupled via the valve apparatus 14 alternatively to the individual guiding channels or chambers 9 and 12. The feeder line 37 is equipped to the connection C, the return line 38 forms the connection B. A controllable pressure limitation valve 39 is added to the return line 38 for pressure control, which can limit the pressure in the return line 38 to a specific value. For supplying the operating resources, a conveyor device 40 is also present. This makes it possible for the power transfer to occur at the same time via the switchable coupling 17 and the hydrodynamic coupling 1. The power transfer for the switchable coupling 17 will be controlled via the differential pressure between both connections B and C and thereby also indirectly via the hydrodynamic branch, i.e. the hydrodynamic coupling 1. Using absolute pressure, the power transfer can be changed via the hydrodynamic coupling.

Another possibility shown in FIG. 7 consists of ordering the means for controlling the pressure directly to the inflow to the toroidal working chamber 4 and the outflor from the toroidal working chamber 4. In this case, the inflow and the outflow B and C from the toroidal working chamber 4 are coupled with one another via a connecting line, which is coupled with an operating resources container 43 via another connecting line 42. Controlling the degree of filling in the toroidal working chamber 4 of the hydrodynamic coupling 1 can occur by changing the absolute pressure p_{absolute} in the toroidal working chamber. For this purpose, the individual connections B and C are each equipped with a controllable valve apparatus 44 and 45 to control pressure in the inflow and reverse flow—each according to the arrangement of the

individual connections B and C as an inflow line or outflow line. In the simplest case, as presented in this Figure, these are executed as controllable pressure valve apparatuses that are independent of each other. The connection lines 41 and 42 and the connections B and C and the operating resources container 43 form an operating resources supply system 46. To avoid conveyance operation against the resistance of the valve apparatuses 45 and 46, there will preferably be a pressure release valve 47 in the connection line 41.

By means of the pressure regulation valves, both the flow direction and the transferable power in the hydrodynamic coupling will be determined by the pressure values to be set in the guiding channels and chambers 9 and 12. In addition, the transferable power portions are controllable individually or jointly via any coupling—hydrodynamic coupling 1 and switchable coupling 17. A first power portion will be transferred during parallel operation of the hydrodynamic coupling 1 and the switchable coupling 17 via an initial power branch, in which the hydrodynamic coupling 1 is arranged. A second power portion is transferred via a second power branch in which the switchable coupling 17 is arranged. Controlling of the first power portion occurs via control of the absolute pressure in the hydrodynamic coupling 1. The pressure being exerted on the guiding channel or chamber 12 functions as a control variable for this process. Control of the second power portion is realized via the differential pressure placed upon the connections B and C.

Reference Number List

1. hydrodynamic coupling

2. pump wheel

3. turbine wheel

4. toroidal working chamber

5. work cycle

6. pump wheel shell

7. external periphery of the turbine wheel

8. internal contour

9. guiding channel or chamber

10. extreme radial measurement of the hydrodynamic coupling

11. separation plane

12. guiding channel or chamber

13. means for directional change of flow through direction

14. directional valve apparatus

15. internal periphery

16. starter unit

17. switchable coupling

18. bridge coupling

19. first thrust plate

20. second thrust plate

21. means for generating contact pressure

22. piston element

23. mounting element

24. flex plates

25. crankshaft

26. blade base

27. internal diameter

28. external diameter

29. device for attenuation of oscillations

30. primary part

31. secondary part

32. open sytem

33. inflow

34. outflow

35. work cycle

36. container

37. feed line

38. return line

39. pressure limitation valve

40. conveyance apparatus

41. connecting line

42. connecting line

43. container

44. pressure control valve

45. pressure control valve

46. operating resources supply system

47. pressure release valve

A. exit of the starter unit

B. connection

C. connection

E. entry of the starter unit

1. Hydrodynamic coupling (1; 1.4)
1.1 with two blade wheels—a pump wheel (2; 2.4) and a turbine wheel (3; 3.4)—that together form a toroidal working chamber (4; 4.4);
1.2 with a pump wheel shell (6; 6.4) coupled in a rotationally fixed manner with the pump wheel (2; 2.4) which surrounds the turbine wheel (3; 3.4) in an axial direction via formation of a first guiding channel or chamber (9; 9.4);
1.3 with a second guiding channel or chamber (12; 12.4) which leads into the area of the internal diameter of the toroidal working chamber (6; 6.4) or below it;
1.4 the first and second guiding channel or chamber (12; 12.4) may alternatively be used as a inflow or outflow channel or chamber to or from the toroidal working chamber (4; 4.4).

2. Hydrodynamic coupling (1; 1.4) as described in claim 1, characterized by the fact that both blade wheels (2; 2.4; 3; 3.4) are executed, taking size into consideration, with a small skew notch opposite each other in a radial direction.

3. Hydrodynamic coupling (1; 1.4) as described in either claim 1 or 2, characterized by the fact that arrangement of the second guiding channel or chamber (12; 12.4) occurs at least in the pump wheel or turbine wheel axel.

4. Hydrodynamic coupling (1; 1.4) as described in one of the claims 1 through 3, characterized by the fact that the first and second
guiding channel or chamber (9, 12; 9.4, 12.4) are pressure insulated against each other.

5. Operating resources system (46) for a hydrodynamic coupling (1; 1.4) as described in one of the claims 1 through 4;
5.1 with an operating resources supply source (40; 43; 36);
5.2 with a first connection (B) for coupling with the first guiding channel or chamber (9; 9.4);
5.3 with a second connection (C) for coupling with the second guiding channel or chamber (12; 12.4);
5.4 with means (14, 13) for optional change in flow direction of the hydrodynamic coupling (1; 1.4) through allocation of the inflow or outflow function to both guiding channels or chambers (9, 12; 9.4, 12.4).

6. Operating resources supply system (46) as described in claim 5, characterized by the following characteristics:
6.1 the means (14) encompass a valve apparatus (13) with at least to switch settings (I, II);
6.2. a first switch setting (I) is characterized by the coupling between inflow and the first guiding channel or chamber (9; 9.4) and outflow and the second guiding channel or chamber (12; 12.4);
6.3 a second switch setting (II) is characterized by the coupling between inflow and the second guiding channel or chamber (12; 12.4) and outflow and the first guiding channel or chamber (9; 9.4).

7. An operating resources supply system as described in claim 6, characterized by the following characteristics:
7.1 inflow and outflow are connected with each other via an open cycle (32), encompassing an operating resources supply or storage unit (36, 43);
7.3 with means for controlling the transferable power portions via the hydrodynamic coupling and the switchable coupling.

8. An operating resources supply system (46) as described in claim 7, characterized by the fact that the means for controlling the transferable power portions via the hydrodynamic coupling (1; 1.4) and the switchable coupling (17; 17.4) encompass the means (14; 14.4) for optional change in the flow through direction of the hydrodynamic coupling by allocation of the inflow or outflow function to both of the guiding channels or chambers (9, 12; 9.4, 12.4), one each to the individual guiding channel or chamber (9, 12; 9.4, 12.4) and a valve apparatus (39) for controlling pressure in at least one guiding channel or chamber.

9. An operating resources supply system (46) as described in claim 5, characterized by the fact that the means for controlling the transferable power portions and the means for optional change of the flow direction of the hydrodynamic coupling by allocation of the inflow or outflow function to both of the guiding channels or chambers, one each to the individual guiding channel or chamber (9, 12; 9.4, 12.4) are arranged and a separately controllable valve apparatuses (44, 45) are formed.

10. An operating resources supply apparatus (46) as described in claim 9, characterized by the fact that the controllable valve apparatuses (44, 45) are executed as pressure regulation valve apparatuses.

11. Starter unit (16, 16.4)
11.1 with an entry (E) that can be coupled with a drive and an exit (A) that may be coupled with the drive;
11.2 with a starter element in the form of a hydrodynamic coupling (1; 1.4) as described in one of the claims 1 through 4;
11.3 with a switchable coupling (17, 17.4) encompassing at least two thrust plates that may be brought together in a striking connection with each other either directly or indirectly via other transmission means—a first thrust plate (19) and a second thrust plate (20) that are respectively coupled to the entry (E) and the exit (A).

12. A starter unit (16; 16.4) as described in claim 11 characterized by the fact that there are means (21) for generating contact pressure to realize at least an indirect connection between the first thrust plate (19) and the second thrust plate (20).

13. A starter unit (16; 16.4) as described by claim 11 or 12, characterized by the fact that the first thrust plate (19) is connected in a rotationally fixed manner with the pump wheel shell (6, 6.4) and the second thrust plate (20) in a rotationally fixed manner with the turbine wheel (3; 3.4) and the means (21) for realizing at least an indirect striking connection between the first thrust plate (19) and the second thrust plate (20) encompass at least one piston element (22) that may be struck by pressure means.

14. Starter unit (16; 16.4) as described in one of the claims 11-13, characterized by the following characteristics:
14.1 the turbine wheel (3, 3.4) is connected in a rotationally fixed manner, but in an axial direction, with the exit (A) of the starter unit (16; 16.4);
14.2 the piston element (22) is formed by the turbine wheel (3, 3.4);
14.3 a chamber that may be filled with pressure means for striking the piston element (22) is formed by the toroidal working chamber (4, 4.4).

15. A starter unit (16, 16.4) as described in claim 11 through 13, characterized by the following characteristics:
15.1 the turbine wheel (3, 3.4) is connected in a rotationally fixed manner with the exit (A), whereby the coupling is executed to rotate stiffly in the periphery direction, but elastically in an axial direction;
15.2 the piston element (22) is formed by the turbine wheel (3, 3.4);
15.3 a chamber that may be filled with pressure means for striking the piston elements is formed by the toroidal working chamber (4; 4.4).

16. A starter unit (16, 16.4) as described in one of the claims 11 through 15, characterized by the following characteristics:
16.1 the first thrust plate (19) and/or the second thrust plate (20) are executed in one part with the pump wheel shell (6; 6.4) and/or with the turbine wheel (3, 3.4);
16.2 the pump wheel shell (6; 6.4) and/or the turbine wheel (3, 3.4) are coated with a striking layer.

17. A starter unit (16; 16.4) as described in one of the claims 11 through 15, characterized by the following characteristics:
17.1 the first thrust plate (19) and/or the second thrust plate (20) are executed as a separate design element, which are connected in a rotationally fixed manner with the pump wheel shell (6; 6.4) and/or the turbine wheel (3; 3.4);
17.2 the striking surfaces are formed from the separate design elements or a striking layer placed on the element.

18. A starter unit (16; 16.4) as described in one of the claims 11 through 17, characterized by the fact that the second thrust plate (20) is arranged on the backside of the turbine wheel (3; 3.4).

19. A starter unit (16; 16.4) as described in claim 18, characterized by the fact that the second thrust plate (20) is arranged in a radial direction in an area between the external diameter and the internal diameter of the toroidal working chamber (4; 4.4).

20. A starter unit (16; 16.4) as described in one of the claims 11 through 19, characterized by the fact that the first thrust plate (19) and the second thrust plate (20) are aligned parallel to the separation plane (11) between the pump wheel (2; 2.4) and the turbine wheel (3; 3.4).

21. A starter unit (16; 16.4) characterized by the following characteristics:
21.1 with a device (29; 29.4) for attenuation of oscillations, in particular a torsion oscillation attenuator;
21.2 the device (29; 29.4) for attenuation of oscillations is switched in a sequence with the hydrodynamic coupling (1; 1.4) and the switchable coupling (17; 17.4).

22. A starter unit (16; 16.4) as described in claim 21, characterized by the fact that the device (29; 29.4) for attenuation of oscillations is arranged between the turbine wheel (3; 3.4) and the exit (A).

23. A starter unit (16; 16.4) as described in one of the claims 21 or 22, characterized by the fact that the device (29; 29.4) for attenuation of oscillations is executed as a strike attenuation apparatus.

24. A starter unit (16; 16.4) as described in one of the claims 21 or 22, characterized by the fact that the device (29; 29.4) for attenuation of oscillations is executed as a hydraulic attenuation apparatus.

25. A starter unit (16; 16.4) as described in claim 24, characterized by the following characteristics:
25.1 the device (29; 29.4) for attenuation of oscillations (22) encompasses a primary part (30) and a secondary part (31), which are coupling with one another in the periphery direction in a rotationally fixed manner, but allow limited rotation against each other;
25.2 means for an attenuation and/or spring coupling are arranged between the primary part (30) and the secondary part (31).

26. A starter unit (16; 16.4) as described in one of the 11 through 25, characterized by the fact that the turbine wheel (3.4) is spatially arranged between the entry (E) and the pump wheel (2.4).

27. A starter unit (16; 16.4) as described in one of the claims 11 through 25, characterized by the fact that the turbine wheel (3) is arranged spatially behind the pump wheel (2) and the pump wheel (2) between the entry (E) and the turbine wheel (3).

28. A starter unit (16; 16.4) as described in one of the claims 11 through 27, characterized by the fact that these components encompass an operating resources supply system (46) as described in claims 5 through 10.

29. A gear design element with a starter unit (16; 16.4) as described in one of the claims 11 through 18.

30. A gear design element as described in claim 29, characterized by the fact that the exit (A) of the starter unit (16; 16.4) is coupled with at least one power gear step.

31. A gear design element as described in one of the claims 29 or 30, characterized by the fact that the exit (A) of the starter unit (16; 16.4) is coupled with a step-less gear part.

32. A gear design element as described in one of the claims 29 or 30, characterized by the fact that this is executed as machine gear.
